(19) United States
(12) Patent Application Publication
(10) Pub. No.: US 2012/0194088 A1
(43) Pub. Date: Aug. 2, 2012

(54) HIGH BRIGHTNESS LED DRIVING CIRCUIT

(75) Inventor: Cheng-Hung Pan, Taipei (TW)

(73) Assignee: Luxul Technology Incorporation, Taipei (TW)

(21) Appl. No.: 13/347,026

(22) Filed: Jan. 10, 2012

Related U.S. Application Data
(60) Provisional application No. 61/438,208, filed on Jan. 31, 2011.

(51) Int. Cl. H05B 37/02

(52) U.S. Cl. 315/193

(57) ABSTRACT

A high brightness LED driving circuit has a rectifying unit, an LED string, multiple electric switches, a current detection unit and a current adjusting unit. The current adjusting unit turns on and off the electric switches to form a corresponding order current loop. The LED string has multiple LED units. The order of the current loop indicates the number of the LED units being activated. The LED units in each order current loop has the LED units in the previous lower order current loops. In the cycle of voltage-rising period and the voltage-dropping period, the current adjusting unit turns on one electric switch to respectively form a higher and a lower order current loop. Therefore, the brightness of the LED string should be uniform.

### BACKGROUND OF THE INVENTION

1. Field of the Invention

The present invention relates to a driving circuit, and more particularly to a high brightness LED driving circuit.

2. Description of Related Art

In the field of illumination, light-emitting diodes (LEDs) take the place of conventional bulbs because of their low cost and low power dissipation characteristics.

FIG. 5 plots a typical voltage versus current waveform of an LED device. The LED device allows a current flow to pass in one direction called a forward direction. The LED device will not be turned on unless a forward voltage applied to the LED is larger than a threshold voltage of the LED, wherein the threshold voltage is approximately 0.7V. FIG. 6 plots a current versus luminous intensity diagram of the LED device under 25° C. With a larger current flow passing through the LED device, the luminous intensity of the LED device becomes stronger. A common driving circuit usually outputs a stable current to the LED device to maintain the brightness and life of the LED device.

The LED device only works in the forward bias voltage. With reference to FIG. 7, if the LED receives an AC voltage V_{AC} directly, the LED is activated only during one segment T during which the amplitude of the AC voltage V_{AC} is larger than the threshold voltage existing in each cycle of the AC voltage V_{AC}, and is turned off in the rest of time, causing the low luminous efficiency of the LED.

With reference to FIG. 8, a common LED driving circuit in prior art has a rectifier 6 and a filtering capacitor C. An input of the rectifier 6 is connected electronically to an AC voltage V_{AC}. The filtering capacitor C is electronically connected to the output of the rectifier 6. With further reference to FIG. 9, the rectifier 6 and the filtering capacitor C convert the AC voltage V_{AC} to a DC voltage. However, the charging and discharging states of the filtering capacitor C cause a ripple in the output voltage of the rectifier 6. Therefore, the output current as shown in FIG. 10 is not a constant current. With reference to FIG. 11, an additional constant current circuit can be connected to the output of the rectifier 6 to eliminate the ripple and generate a stable DC current to provide to an LED.

With reference to FIG. 12, although the filtering capacitor C will stabilize the output voltage, it will also cause the phase difference between the input current and the input voltage of the rectifier 6 and lower the power factor.

In order to raise the power factor, more and more LED driving circuits without capacitor and inductor elements are disclosed. With reference to FIG. 13, an LED driving circuit disclosed in U.S. Pat. No. 6,989,807 comprises a full-wave rectifier 60, an LED lamp 70, multiple electric switches 81-85 and a voltage detection unit 90.

An input of the full-wave rectifier 60 is electronically connected to an AC voltage, and an output of the full-wave rectifier 60 outputs a sine DC voltage.

The LED lamp 70 comprises multiple LED units connected in series. Each LED unit 71-75 comprises at least one LED. With reference to FIG. 13, the LED lamp 70 comprises a first LED unit 71, a second LED unit 72, a third LED unit 73, a fourth LED unit 74 and a fifth LED unit 75. The LED units 71-75 are electronically connected to the electric switches 81-85 respectively. The electric switches 81-85 comprise a first electric switch 81, a second electric switch 82, a third electric switch 83, a fourth electric switch 84 and a fifth electric switch 85. Each electric switch 81-85 has a control terminal.

The voltage detection unit 90 is electronically connected to the output terminal of the full-wave rectifier 60. The voltage detection unit 90 has five output terminals being electronically connected to the control terminals of the electric switches 81-85 respectively. The voltage detection unit 90 has five default values, respectively named as a first threshold voltage Vth1, a second threshold voltage Vth2, a third threshold voltage Vth3, a fourth threshold voltage Vth4 and a fifth threshold voltage Vth5, wherein the Vth1 is the minimum and the vth5 is the maximum. The voltage detection unit 90 detects the amplitude of the sine DC voltage from the full-wave rectifier 60. The voltage detection unit 90 controls the electric switches to form a certain current loop based on the relationship between the amplitude of the sine DC voltage and the default values.

With reference to FIG. 14, in every cycle of the sine DC voltage, the voltage detection unit 90 will not turn on any electric switch when the amplitude of the sine DC voltage is lower than the first threshold voltage Vth1. When the voltage detection unit 90 detects that the amplitude of the sine DC voltage is greater than the first threshold voltage Vth1 and lower than the second threshold voltage Vth2, the voltage detection unit 90 turns on the first electric switch 81. Therefore, the first LED unit 71 is activated because the LED unit 71 and the AC voltage V_{AC} form the current loop.

Meanwhile, the amplitude of the sine DC voltage is still gradually rising. When the voltage detection unit 90 detects that the amplitude of the sine DC voltage is larger than the second threshold voltage Vth2 and lower than the third threshold voltage Vth3, the voltage detection unit 90 turns off the first electric switch 81 and turns on the second electric switch 82. Therefore, the first LED unit 71 and the second LED unit 72 are activated because the first LED unit 71, the second LED unit 72 and the AC voltage V_{AC} form a new current loop.

As a result, the voltage detection unit 90 only turns on the fifth electric switch 85 when the voltage detection unit 90 detects that the amplitude of the sine DC voltage is larger than the fifth threshold voltage Vth5. Therefore, all of the LED units 71-75 are activated.

Similarly, the amplitude of the sine DC voltage starts to decrease after the peak position. In the cycle that the amplitude of the sine DC voltage decreases, the voltage detection unit 90 will sequentially turn on and turn off the electric switches 85-81 based on the comparison results of the sine DC voltage and the threshold voltages Vth1-Vth5.

However, the threshold voltages Vth1-Vth5 are preset in the voltage detection unit 90 as default values. Setting the threshold voltage Vth1-Vth5 should take account of the forward conducting voltage of each LED. If a preset threshold voltage is larger than the forward conducting voltage of an LED unit, the LED unit will be activated in larger amplitude of the sine DC voltage causing more power dissipation.

Moreover, if the preset threshold voltage is lower than the forward conducting voltage of the LED unit, the voltage detection unit 90 will turn on a corresponding electric switch to form a current loop in advance. That indicates the current flow of the current loop is not sufficient. Therefore, the brightness of the LED units is darker.

Moreover, the threshold voltages of the LEDs are different. The threshold voltage of the LED may vary with temperature. Therefore, to preset the threshold voltages in the voltage detection unit 90 does not satisfy every working condition.

### SUMMARY OF THE INVENTION

The main objective of the present invention is to provide a high brightness LED driving circuit that comprises a rectifying unit, an LED unit, multiple electric switches, a current detection unit and a current adjusting unit.

The rectifying unit has two output terminals to output a DC voltage. The LED string has a first terminal connected to one output terminal of the rectifying unit, a second terminal connected to another output terminal of the rectifying unit via a current detection unit, and multiple LED units connected in series. Each LED unit has a cathode. The multiple electric switches are connected between the cathodes of the LED units respectively and the current detection unit to form multiple-order current loops. The LED units in each order current loop comprise the LED units in the previous order current loops. The current adjusting unit is connected to the electric switches and the current detection unit. The current adjusting unit turns on one electric switch to form the corresponding current loops from lower order to higher order in a voltage-rising period of the DC voltage to activate the LED units sequentially. The current adjusting unit turns on one electric switch to form the current loops from higher order to lower order in the voltage-dropping period of the DC voltage to extinguish the LED units sequentially.

Above all, the LED units are activated and extinguished sequentially in one cycle of the DC voltage. Therefore, the LED string could brighten uniformly. Contrasting to the LED driving circuits in prior art, there are no preset threshold voltages in the present invention. The influences of the conducting conditions of LEDs are avoided. The current adjusting unit can form the certain current loop precisely to make the LED string brighten uniformly. Moreover, there are no capacitor and inductor devices being used. The power factor of the present invention is better than that in the prior art.

Other objectives, advantages and novel features of the invention will become more apparent from the following detailed description when taken in conjunction with the accompanying drawings.

### BRIEF DESCRIPTION OF THE DRAWINGS

FIG. 1 is a circuit diagram of a first embodiment of a high brightness LED driving circuit in accordance with the present invention;

FIG. 2 is a waveform diagram showing different control signals used in the high brightness LED driving circuit in accordance with the present invention;

FIG. 3 is a waveform diagram of an AC voltage, the LED string and the current flow in a current loop of a first embodiment of a high brightness LED driving circuit in accordance with the present invention;

FIG. 4 is a waveform diagram of another sine DC voltage, the LED string and the current flow in a current loop of another embodiment of a high brightness LED driving circuit in accordance with the present invention;

FIG. 5 is a voltage-versus-current waveform diagram of an LED;

FIG. 6 is a luminous intensity-versus-current waveform diagram of an LED under room temperature;

FIG. 7 is a waveform diagram of an AC voltage without rectifying;

FIG. 8 is a circuit diagram of an AC voltage, a rectifying unit and a filtering capacitance;

FIG. 9 is a waveform diagram of a filtered DC voltage;

FIG. 10 is a waveform diagram of a current flow;

FIG. 11 is a waveform diagram of a current flow;

FIG. 12 is a waveform diagram of a current and a voltage at the input of the rectifying unit;

FIG. 13 is a known circuit diagram of an LED driving circuit; and

FIG. 14 is a waveform diagram of an AC voltage, the LED string and the current flow in a current loop of a conventional LED driving circuit.

### DETAILED DESCRIPTION OF THE PREFERRED EMBODIMENT

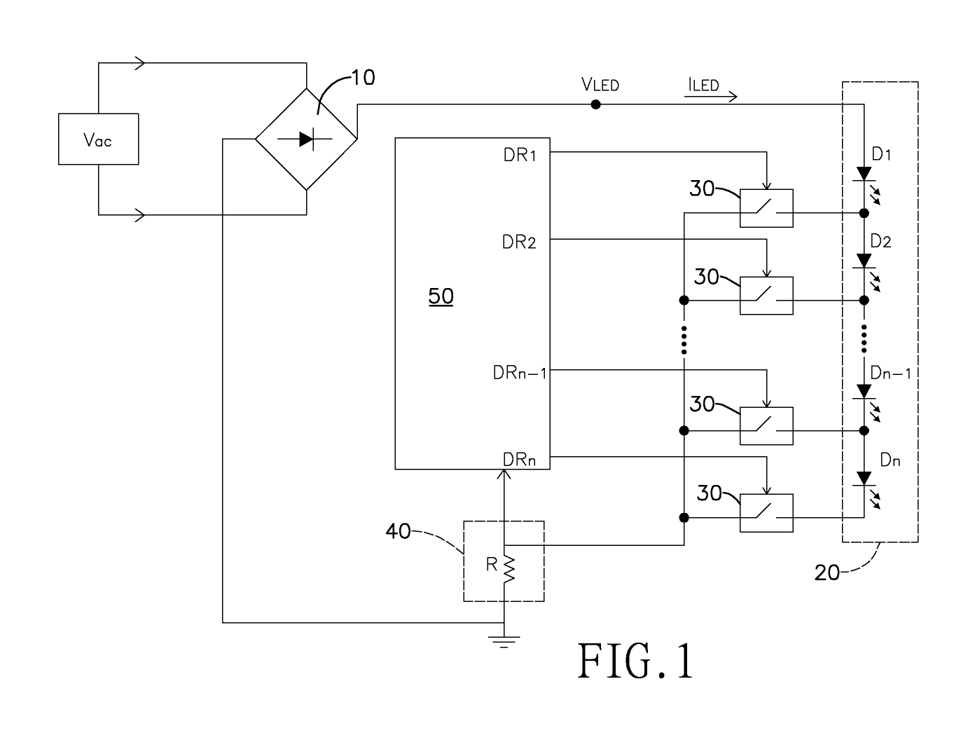

With reference to FIG. 1, a first embodiment of a high brightness LED driving circuit in accordance with the present invention has a rectifying unit 10, an LED string 20, multiple electric switches 30, a current detection unit 40 and a current adjusting unit 50.

The rectifying unit 10 has two output terminals. The rectifying unit 10 converts an AC voltage V_{AC} into a DC voltage outputted from the two output terminals. In the first embodiment, the rectifying unit 10 is a full-wave rectifier outputting a sine DC voltage.

The LED string 20 has a first input terminal and a second input terminal. The first input terminal is electronically connected to one output terminal of the rectifying unit 10. The second input terminal of the LED string 20 is electronically connected to the other output terminal of the rectifying unit 10 via the current detection unit 40. The LED string 20 comprises multiple LED units D1-Dn connected in series. Each LED unit D1-Dn has a cathode. Each LED unit D1-Dn may comprise an LED or multiple LEDs connected in series or in parallel.

The current detection unit 40 comprises at least one resistor R. The current detection unit 40 generates a current detecting signal V_{LSENSE} standing for the current flow in a present current loop.

Each electric switch 30 has a control terminal. The multiple electric switches 30 are electronically connected between the cathodes of the LED string 20 and the current detection unit 40 respectively to form current loops from low order to high order. The order of the current loop indicates the number of the LED units D1-Dn being activated. The LED units in each current loop of a higher order comprise the LED units of a current loop of a previous order. For example, a fifth order current loop comprises five LED units. The current loop of the n-th order comprises n LED units. Each electric switch 30 is controlled to turn on or off when the electric switch 30 receives a control signal from its control terminal. When the electric switch 30 is turned on, a corresponding current loop is formed. The electric switches 30 can be MOSFETs. The gate of the MOSFET is set as the control terminal.

The current adjusting unit 50 has multiple output terminals DR1-DRn electronically connected to the control terminals of the electric switches 30 respectively. The current adjusting unit 50 generates control signals for turning on or off the electric switches 30 selectively. The current adjusting unit 50 has an input terminal, which is electronically connected to the current detection unit 40 and receives the current detecting signal V_{LSENSE}. In this embodiment, the current adjusting unit 50 is electronically connected to one end of the resistor R. The terminal voltage of the resistor R V_{LSENSE} represents the current flow I_{LED} of the present current loop.

In the period that the sine DC voltage is rising, the current adjusting unit 50 turns on electric switches 30 to form different current loops from low order to high order to activate the LED units sequentially.

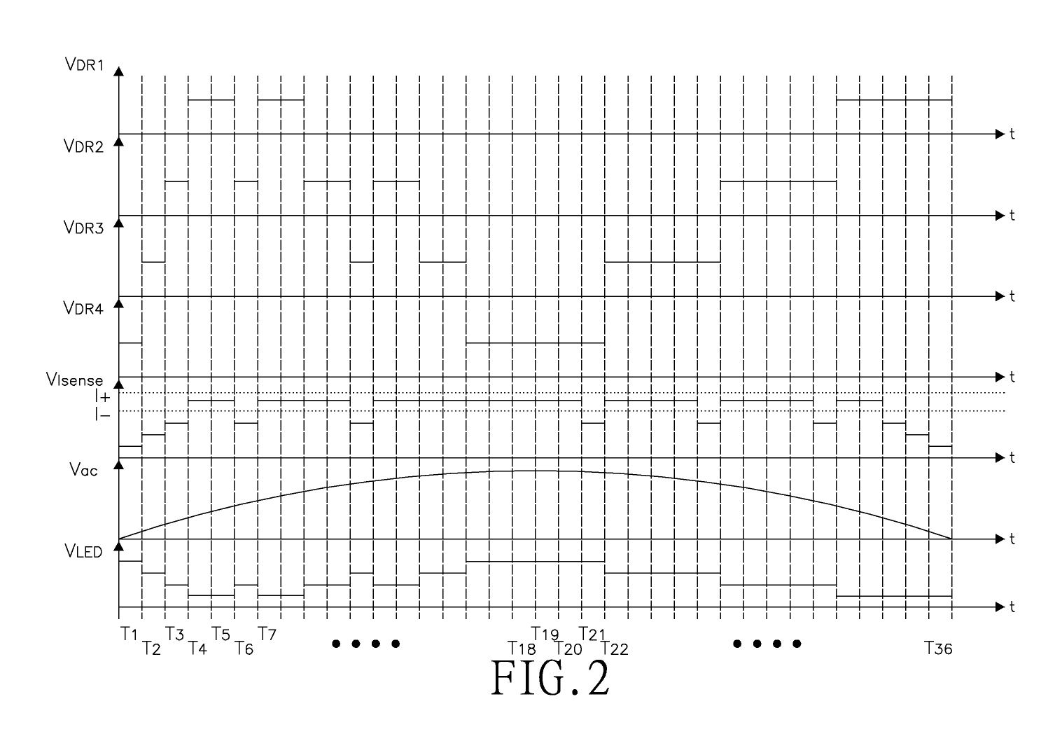

With reference to FIG. 2, in this embodiment, the current adjusting unit 50 has a minimum current value I− and a maximum current value I+ as default values. The minimum current value I− and the maximum current value I+ form a standard current range. The current adjusting unit 50 turns on or off one electric switch 30 to form a corresponding current loop according to the current-detecting signal V_{LSENSE}.

A complete cycle of a sine DC voltage V_{LED} comprises a voltage-rising period and a voltage-dropping period. The voltage-rising period and the voltage-dropping period are separated into several sections T1-T36. The circuit operations of the current adjusting unit 50 in the two periods are discussed below.

In this embodiment, the LED string 20 comprises a first LED unit D1, a second LED unit D2, a third LED unit D3 and a fourth LED unit D4. The four LED units D1-D4 are electronically connected to four electric switches 30 respectively.

In the first section T1 as an initial state, the current adjusting unit 50 is assumed to turn on the electric switch 30 to form the fourth current loop comprising four LED units D1-D4. Because the amplitude of the sine DC voltage V_{LED} is low, the current-detecting signal V_{LSENSE} detected from the fourth current and representing the current flow of the fourth current loop is lower than the standard current range. As the amplitude of the sine DC voltage V_{LED} rises, in the second segment T2, the current adjusting unit 50 turns off the present conducted electric switch 30 to break the fourth current loop, and turns on another electric switch 30 to form a third current loop. Because the third current loop comprises three LED units D1-D3 fewer than four LED units D1-D4 in the fourth current loop, there will be a larger current flow in the third current loop than that in the fourth current loop. Since the current flow in the third current loop becomes larger, the current-detecting signal V_{LSENSE} representing the current of the third current loop becomes larger.

With reference to FIG. 2, in the third section T3, although the current flow in the third current loop has become larger, the current-detecting signal V_{LSENSE} is still beyond the standard current range. The current adjusting unit 50 turns off the present electric switch 30 by outputting the control signal from the output terminal DR3 to break the third current loop, and then turns on another electric switch 30 by outputting the control signal from the terminal DR2 to form the second current loop, and so on. As a result, the current adjusting unit 50 determines whether the current-detecting signal V_{LSENSE} is in the standard current range to control the on and off states of the electric switches 30. If the current-detecting signal V_{LSENSE} is lower than the standard current range, the current adjusting unit 50 turns off the present electric switch to break the present current loop, and then turns on another electric switch to form the lower order current loop.

The current adjusting unit 50 is preset with a detection period. In the voltage-rising period of the sine DC voltage V_{LED}, such as the first section T1 to the eighteenth section T18, the current adjusting unit 50 periodically and sequentially tries to form the higher order current loop within the detection period. Meanwhile, if the current adjusting unit 50 determines that the current-detecting signal V_{LSENSE} is lower than the standard current range, the current adjusting unit 50 turns off the present electric switch 30 to break the present current loop, and then turns on another electric switch 30 to form the lower order current loop to ensure that the current-detecting signal V_{LSENSE} will be in the standard current range. For example, in the fourth section T4 and the fifth section T5, the current-detecting signal V_{LSENSE} is in the standard current range. The current adjusting unit 50 turns off the present electric switch 30 to break the present first current loop, and then turns on another electric switch 30 to form the next order current loop, the second current loop. However, in the sixth section T6, the current-detecting signal V_{LSENSE} in the second current loop is lower than the standard current range. Therefore, in the seventh section T7, the current adjusting unit 60 breaks the second current loop and then forms the first current loop again to ensure that the current-detecting signal V_{LSENSE} will be within the standard current value. Moreover, if the current-detecting signal V_{LSENSE} is still in the standard current range after forming the higher order current loop, the current adjusting unit 50 will turn on one of the electric switches 30 to form the next higher order current loop in the next section. Therefore, in the voltage-rising period, the current adjusting unit 50 controls the electric switches 30 to form the higher order current loop sequentially to activate more LED units D1-D4.

During the voltage-dropping period such as T19 to T36 sections, the current flowing in the current loop will gradually become lower in response to the decreased voltage V_{LED}. If the current adjusting unit 50 detects that the current-detecting signal V_{LSENSE} is lower than the standard current range, the current adjusting unit 50 turns off the present electric switch 30 to break the present current loop, and then turns on another electric switch 30 of the lower order current loop to form the lower order current loop. When the lower order current loop is formed, fewer LED units are activated. As fewer LED units are activated, the current flow in the current loop rises to increase the current-detecting signal V_{LSENSE}. For example, because the current-detecting signal V_{LSENSE} detected in the fourth order current loop is lower than the standard current range in the twenty-first section T21, the current adjusting unit 50 turns off the present electric switch 30 to break the present fourth current loop, and then turns on another electric switch 30 to form the lower order current loop, i.e. the third order current loop, in the twenty-second segment T22. When the third order current loop is established, the current flow in the third order current loop becomes larger since fewer LED units are activated. As the current flow in the present current loop increases, the current-detecting signal V_{LSENSE} becomes larger and can be in the standard current range. In short, the current adjusting unit 50 traces the gradually-reduced sine DC voltage to form the lower order current loop to activate the LED units D1-D4.

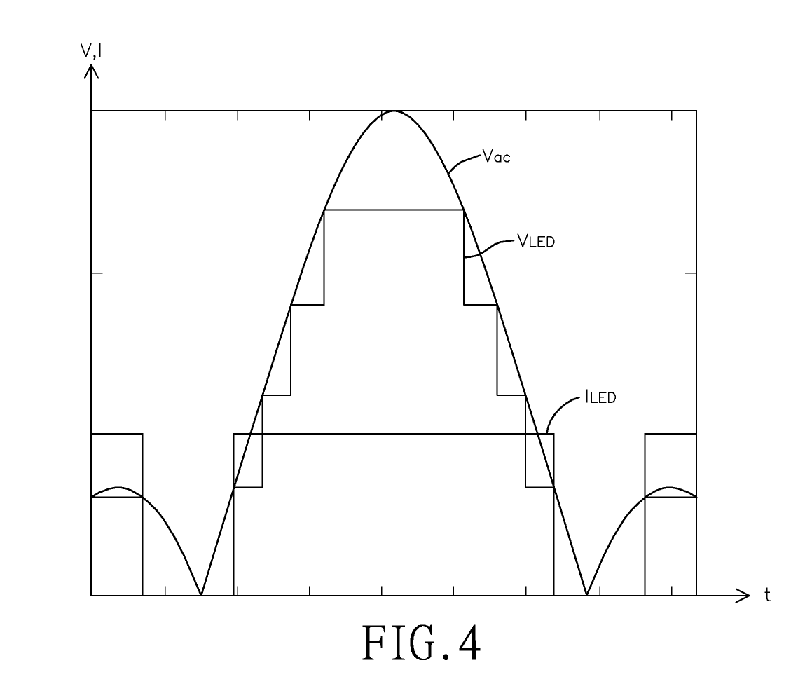

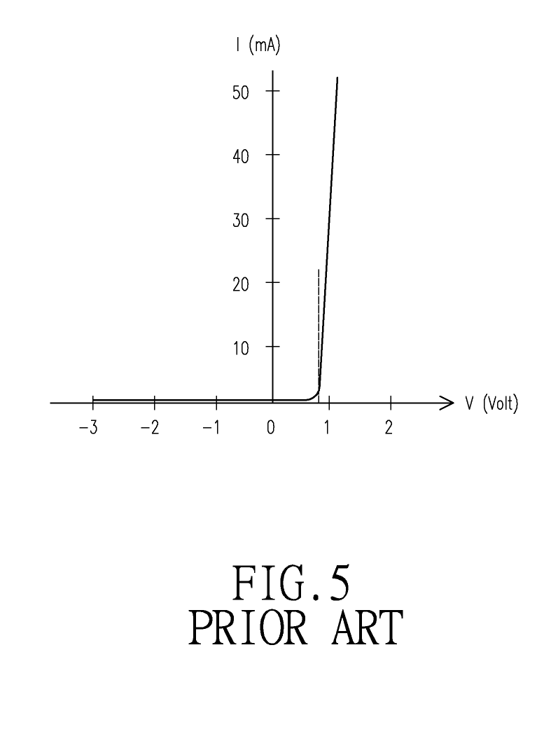

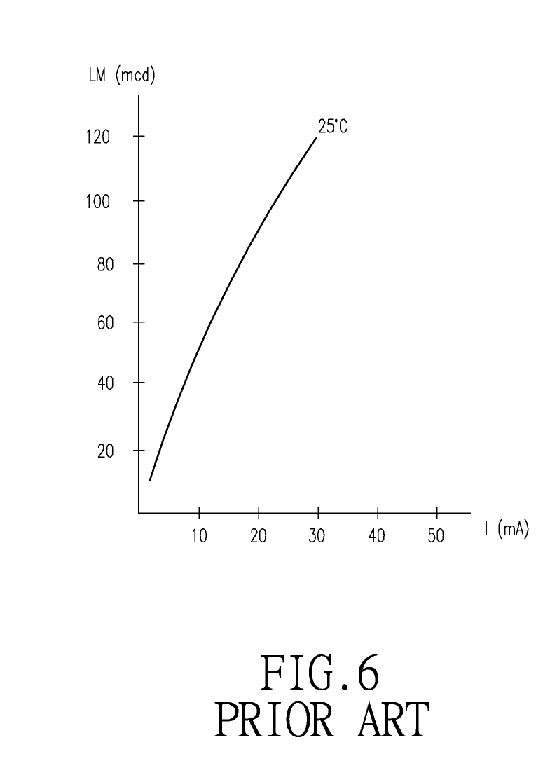

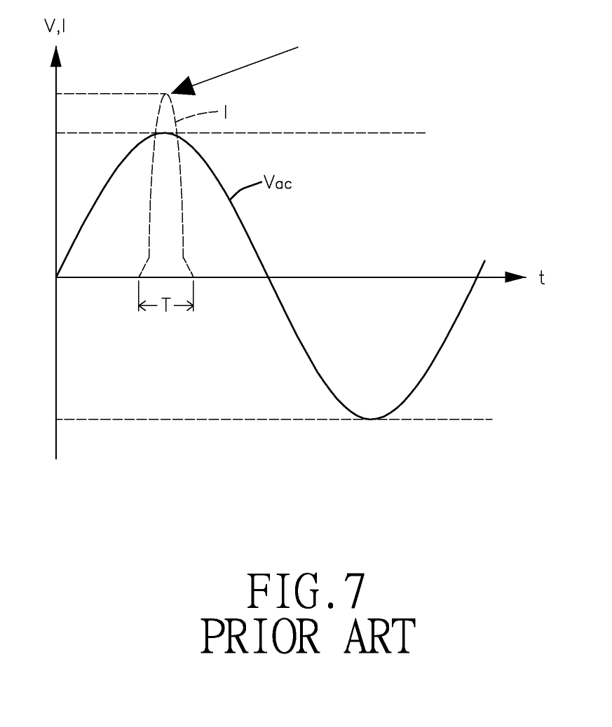

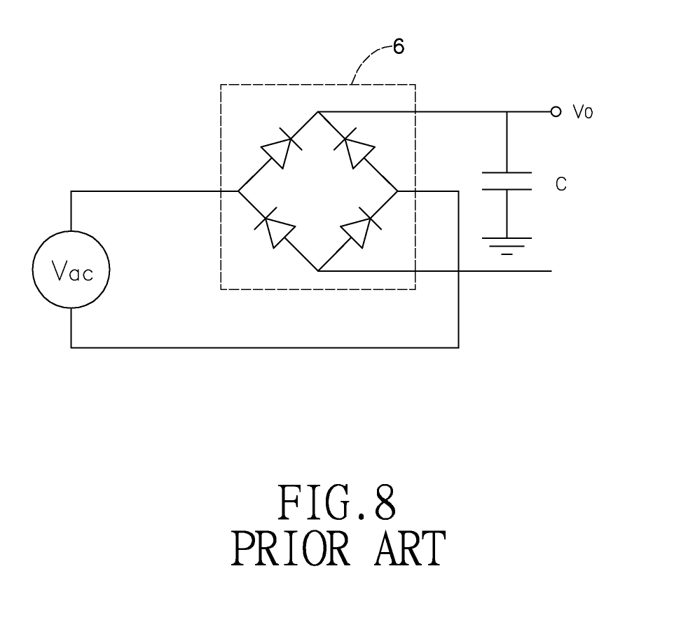

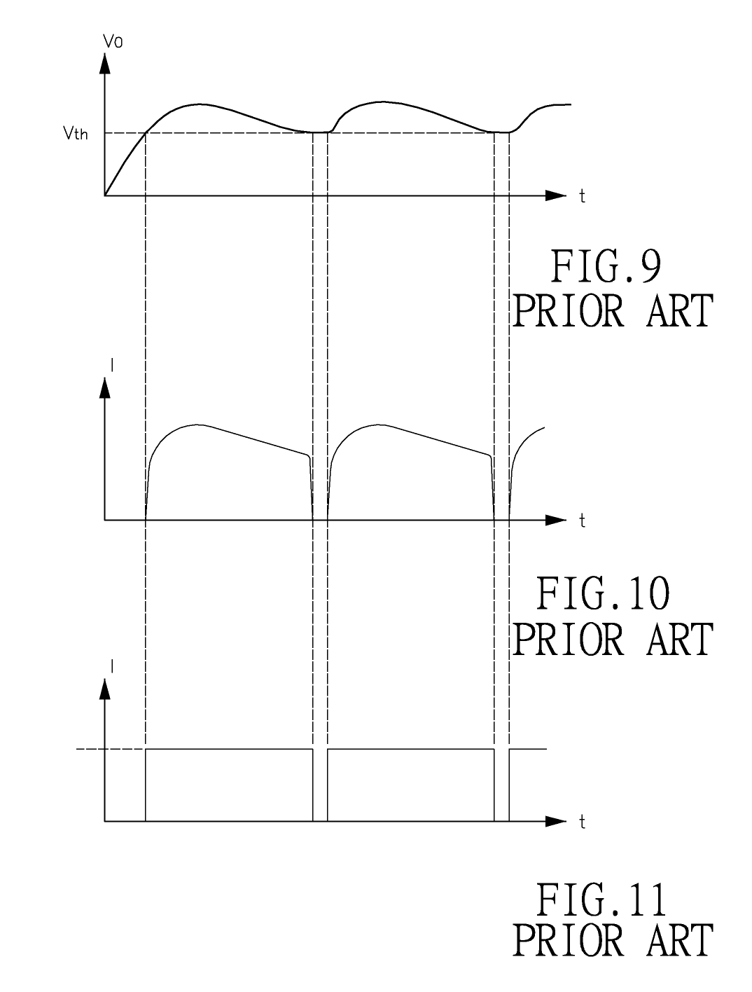

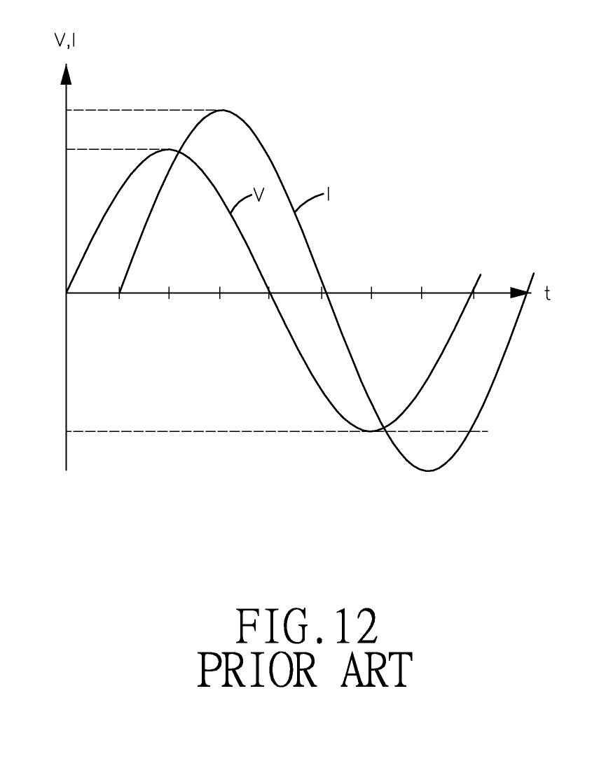

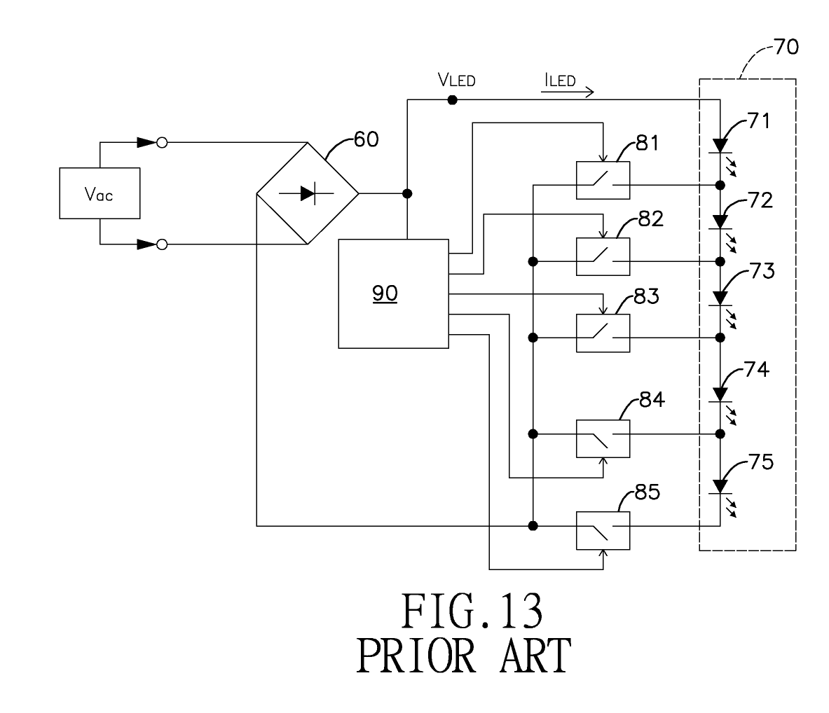

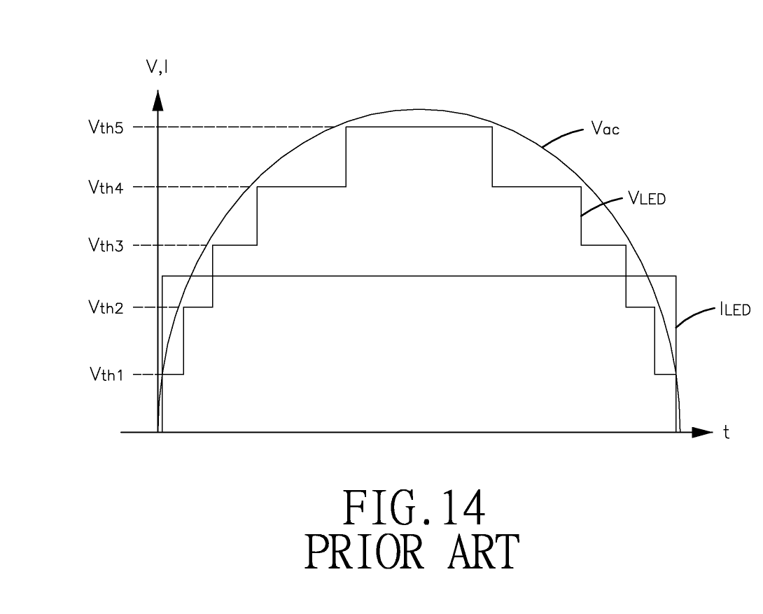

FIG. 4 plots another type of the sine DC voltage. Although the amplitude of the sine DC voltage is not a constant, the current adjusting unit 50 still determines whether the current-detecting signal V_{LSENSE} is in the standard current range to form a corresponding current loop. Therefore, the present invention is applicable for various sine DC voltage types.

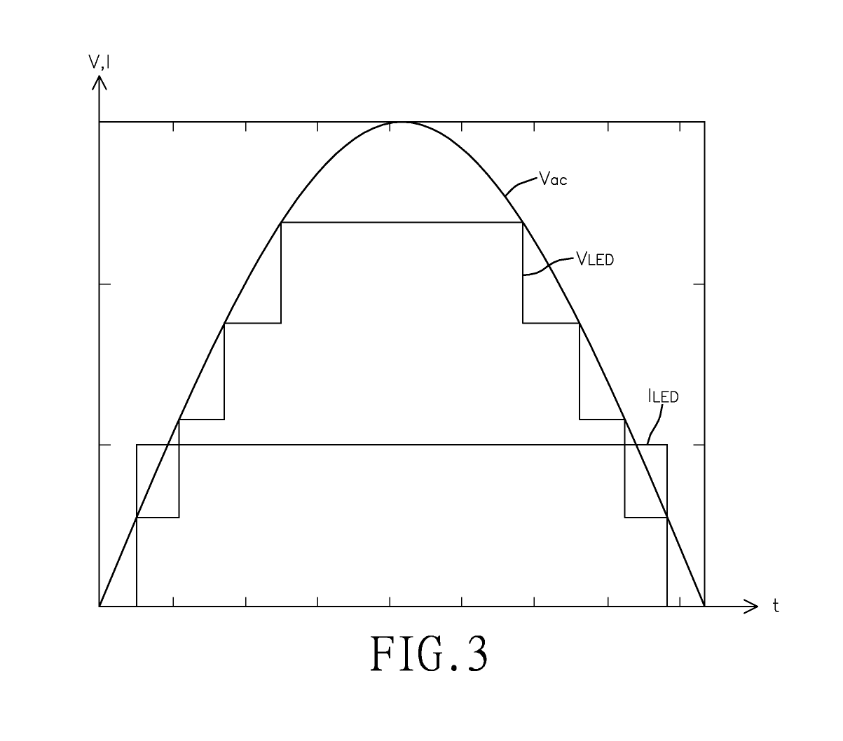

According to the present invention, the current adjusting unit 50 controls the on and off states of the electric switches 30 to form the corresponding current loop based on a comparison result of the current-detecting signal V_{LSENSE} to the standard current range. As a result, in the cycle of voltage-rising period, the current adjusting unit 50 turns on a corresponding electric switch 30 to form the higher order current loop to activate the LED units sequentially. In the cycle of voltage-dropping period, the current adjusting unit 50 turns on a corresponding electric switch to form the lower order current loop to extinguish the LED units sequentially. With reference to FIG. 3, the current I_{LED} in the present current loop will remain a constant. A constant current makes the LED string 20 brighten uniformly.

What is claimed is:

1. A high brightness LED driving circuit comprising:
a rectifying unit having two output terminals to output a DC voltage having a voltage-rising period and a voltage-dropping period;
an LED string having
a first terminal connected to one output terminal of the rectifying unit;
a second terminal connected to the other output terminal of the rectifying unit via a current detection unit; and
multiple LED units connected in series and each LED unit having a cathode;
multiple electric switches connected between the cathodes of the LED units respectively and the current detection unit to form multiple-order current loops and the LED units in each order current loop comprising the LED units of the previous order current loops; and
a current adjusting unit connected to the electric switches and the current detection unit;
the current adjusting unit turning on one of the electric switches selectively based on the current flow detected from the current detection unit to form one corresponding current loop from lower order to higher order in the voltage-rising period of the DC voltage to activate the LED units sequentially, and turning on one of the electric switches selectively based on the current flow detected from the current detection unit to form the current loops from higher order to lower order in the voltage-dropping period of the DC voltage to extinguish the LED units sequentially.

2. The high brightness LED driving circuit as claimed in claim 1, wherein
the current detection unit generates a current-detecting signal standing for the current flow in the current loop;
the current detection unit has a standard current range; and
the current adjusting unit selectively turns on one of the electric switches based on a comparison result of the current-detecting signal to the standard current range.

3. The high brightness LED driving circuit as claimed in claim 2, wherein
the current adjusting unit forms a higher order current loop periodically;
the current adjusting unit turns off one conducted electric switch to break the present current loop, and turns on one of the electric switches to form a lower order current loop until the current-detecting signal is in the standard current range.

4. The high brightness LED driving circuit as claimed in claim 2, wherein the current detection unit comprises at least one resistor.

5. The high brightness LED driving circuit as claimed in claim 3, wherein the current detection unit comprises at least one resistor.

6. The high brightness LED driving circuit as claimed in claim 1, wherein the electric switches are MOSFET.

7. The high brightness LED driving circuit as claimed in claim 2, wherein the electric switches are MOSFET.

8. The high brightness LED driving circuit as claimed in claim 3, wherein the electric switches are MOSFET.

9. The high brightness LED driving circuit as claimed in claim 4, wherein the electric switches are MOSFET.

10. The high brightness LED driving circuit as claimed in claim 5, wherein the electric switches are MOSFET.
